(19) United States
(12) Patent Application Publication
(10) Pub. No.: US 2012/0330455 A1
(43) Pub. Date: Dec. 27, 2012

(54) DISTRIBUTED CNC TOOLPATH CALCULATIONS

(75) Inventor: Roy Sterenthal, Shoham (IL)

(73) Assignee: CIMATRON LTD., Givat Shmuel (IL)

(21) Appl. No.: 13/577,261

(22) PCT Filed: Mar. 7, 2011
(86) PCT No.: PCT/IB11/50946

§ 371 Date: Aug. 6, 2012

Related U.S. Application Data
(60) Provisional application No. 61/313,807, filed on Mar. 15, 2010.

(51) Int. Cl. G05B 19/19

(52) U.S. Cl. 700/186

(57) ABSTRACT

Apparatus, including a workstation (26) which is configured to receive a toolpath request and to generate a toolpath in response to the toolpath request. The workstation is also configured to divide the toolpath request into multiple service reel quests and to output the service requests over a local network (62). The apparatus also includes a toolpath calculation accelerator (80) which is coupled to receive at least one of the service requests from the workstation via the local network. The accelerator is configured to process each received service request so as to generate a calculation result, and to transfer the calculation result to the workstation via the local network for incorporation of the calculation result into the toolpath generated by the workstation.

### CROSS-REFERENCE TO RELATED APPLICATION

This application claims the benefit of U.S. Provisional Patent Application 61/313,807, filed 15 Mar. 2010, which is incorporated herein by reference.

### FIELD OF THE INVENTION

The present invention relates generally to toolpaths, and specifically to automatic calculation of the toolpaths.

### BACKGROUND OF THE INVENTION

Shaped part removal is a manufacturing method where metal or another solid material is removed from an initial raw stock, such as a bar or rod, using computer numerical controlled (CNC) machines, typically machines such as lathes, drilling, or milling machines. In some cases material may be added to a part, for example by a CNC welding machine. The CNC machines are programmed using a list of motions and control commands, collectively known as a toolpath. Methods for calculating toolpaths are known in the art.

U.S. Pat. No. 6,859,681, to Alexander, whose disclosure is incorporated herein by reference, describes a process for toolpath generation incorporating direct metal deposition of multiple materials. The disclosure states that single- and multi-material files may be merged into one toolpath file. U.S. Patent Application 2010/0316458, to Lindgren et al., whose disclosure is incorporated herein by reference, describes an automated material removal process. The process claims to calculate a toolpath to guide a tool for removing out-of-tolerance material from a composite structure.

U.S. Patent Application 2009/0319394, to Kreidler et al., whose disclosure is incorporated herein by reference, describes a system which involves establishment of a connection over a public network, such as the Internet, between an automated machine tool and a host server. Machine tool data from the production process is gathered and transmitted over the Internet to the host, where the data may be stored and analyzed.

U.S. Patent Application 2003/0046436, to Govindaraj et al., whose disclosure is incorporated herein by reference, describes an “open control interface system” run by a computer. The computer is stated to “facilitate accessing large varieties of CNC data and to provide commands to a CNC that is either resident with the computer or networked.”

U.S. Pat. No. 6,510,361, to Govindaraj et al., whose disclosure is incorporated herein by reference, describes a CNC system which is stated to combine a CNC executive and a logic engine for controlling execution of a part program.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

The description above is presented as a general overview of related art in this field and should not be construed as an admission that any of the information it contains constitutes prior art against the present patent application.

### SUMMARY OF THE INVENTION

An embodiment of the present invention provides apparatus, including:

a workstation, which is configured to receive a toolpath request and to generate a toolpath in response to the toolpath request, and which is configured to divide the toolpath request into multiple service requests and to output the service requests over a local network; and

a toolpath calculation accelerator coupled to receive at least one of the service requests from the workstation via the local network, and to process each received service request so as to generate a calculation result, and to transfer the calculation result to the workstation via the local network for incorporation of the calculation result into the toolpath generated by the workstation.

Typically, the workstation is configured to associate each of the multiple service requests with one of a stock-dependent process and a non-stock-dependent process, wherein the non-stock-dependent process is not dependent on any other process, and wherein the stock-dependent process is dependent on prior implementation of another process.

In one embodiment the at least one service requests received by the accelerator include requests associated with the non-stock-dependent process. The workstation may be configured to process a given service request while the accelerator processes the at least one service requests. Alternatively or additionally, the workstation may be configured to use the calculation result to associate a given service request, initially associated with the stock-dependent process, with the non-stock-dependent process.

In a disclosed embodiment the workstation and the toolpath calculation accelerator are configured to calculate respective priorities indicative of an ability to process the at least one service requests. Typically, the workstation is configured to receive the respective priorities and output the at least one service requests to at least one of the workstation and the accelerator in response to the respective priorities.

The apparatus may include a further toolpath calculation accelerator coupled to receive the at least one service requests from the workstation via the local network, and the further toolpath calculation accelerator may be configured to calculate a further-accelerator priority indicative of an ability to process the at least one service requests, and the workstation may be configured to receive the further-accelerator priority and output the at least one service requests to the workstation, the accelerator and the further toolpath calculation accelerator in response to the respective priorities and the further-accelerator priority.

In an alternative embodiment the apparatus includes a further workstation which is configured to receive a further toolpath request and to generate a further toolpath in response to the further toolpath request, and which is configured to divide the further toolpath request into multiple further service requests and to output the further service requests over the local network, and the toolpath calculation accelerator may be coupled to receive at least one of the further service requests, and to process each received further service request so as to generate a further calculation result, and to transfer the further calculation result to the further workstation via the local network for incorporation of the further calculation result into the further toolpath generated by the further workstation.

Typically, the toolpath calculation accelerator is configured to process the at least one further service requests and the at least one service requests simultaneously.

There is further provided, according to an embodiment of the present invention, a method, including:

configuring a workstation to receive a toolpath request and to generate a toolpath in response to the toolpath request, and to divide the toolpath request into multiple service requests and to output the service requests over a local network; and

coupling a toolpath calculation accelerator to receive at least one of the service requests from the workstation via the local network, and to process each received service request so as to generate a calculation result, and to transfer the calculation result to the workstation via the local network for incorporation of the calculation result into the toolpath generated by the workstation.

The present disclosure will be more fully understood from the following detailed description of the embodiments thereof, taken together with the drawings, in which:

### BRIEF DESCRIPTION OF THE DRAWINGS

FIG. 1 is a schematic block diagram of a client machining facility using a toolpath calculating system, according to an embodiment of the present invention;

FIG. 2 is a schematic block diagram of a toolpath calculation accelerator, according to an embodiment of the present invention;

FIG. 3 is a schematic diagram of a toolpath generating arrangement 120, according to an embodiment of the present invention;

FIG. 4 is a flowchart, according to an embodiment of the present invention;

FIG. 5 is a schematic diagram illustrating full toolpath file generation, according to an embodiment of the present invention; and

FIG. 6 is a schematic diagram of an alternative toolpath generating arrangement, according to an embodiment of the present invention.

### DETAILED DESCRIPTION OF EMBODIMENTS

### Overview

In an embodiment of the present invention, one or more workstations are coupled to one or more toolpath calculation accelerators via a local network. Each of the workstations is able to receive toolpath requests. The requests are typically initially in the form of a request to produce a part, and a given workstation produces a full toolpath file comprising toolpaths for producing the part.

The workstations divide the toolpath requests into multiple service requests, and are able to off-load some of the service requests for processing by one or more of the calculation accelerators. In response to receiving the service requests, the accelerators calculate toolpath results, which are transferred back to the workstation. The workstation is able to use the calculated toolpath results for further required analysis, and is then able to incorporate the toolpath into the full toolpath file for the part. (The workstation itself is also able to generate toolpaths independently of the accelerators, and incorporate these toolpaths into the toolpath file.)

Each accelerator may calculate a priority value for itself, and transmit the priority value to the workstations on the network. The priority value of a given accelerator is a measure of how able the accelerator is to process service requests, and the workstations may use the priority values in deciding to which accelerators service requests are to be sent.

By coupling calculation accelerators to workstations in a distributed manner via a network, the overall rate of production of toolpaths, and of full toolpath files, is increased. In addition, the demands on each of the workstations are decreased, allowing the workstations to be efficiently used for other tasks.

The accelerators require no configuration or user intervention. Thus, accelerators may be connected to the network, in a “plug-n-play” manner, without any action by an operator of a workstation. Once an accelerator is connected to the network, a workstation (which may typically already be in the process of producing a full toolpath file) sees an acceleration in the rate of production of the file.

### System Description

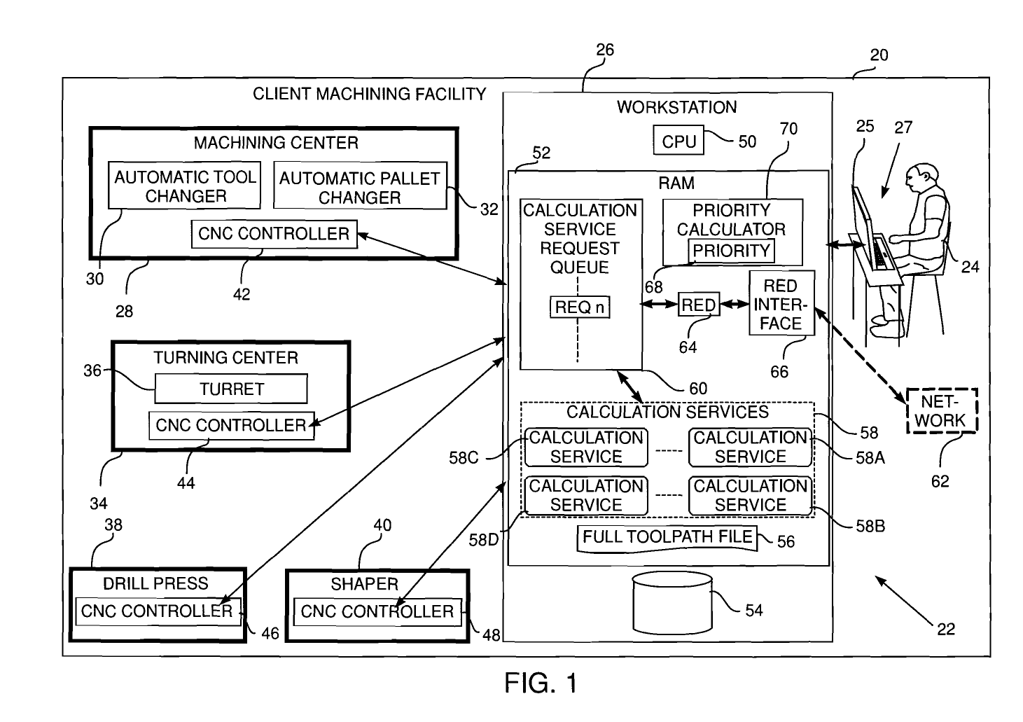

Reference is now made to FIG. 1, which is a schematic block diagram of a client machining facility 20 using a toolpath calculating system 22, according to an embodiment of the present invention. Facility 20 typically comprises a number of individual machines, which may be physically located in a single region, or which may be distributed over a number of different physical sites. For simplicity, in the following description, facility 20 is assumed to be situated in a single region, and those of ordinary skill in the art will be able to adapt the description for the case of a distributed facility.

System 22 is assumed to be operated by an operator 24, via interaction with a computer workstation 26. The operator interaction is typically via a graphic user interface (GUI) 25, and or one or more communication instruments 27 such as a pointing device and/or a keyboard.

Facility 20 comprises a number of computer numerical controlled (CNC) machines, each of which is able to communicate with workstation 26. For the description herein, facility 20 is assumed to comprise:

a machining center 28, which acts as a milling machine and which includes a number of sub-units such as an automatic tool changer 30 and an automatic pallet changer 32;

a turning center 34, which acts as a lathe and which includes an automated turret 36;

a drill press 38; and

a shaper 40.

However, it will be understood that the above list of CNC machines in facility 20 is exemplary, and that the facility may comprise more or less than these numbers of machines, as well as different machines from those listed. Typically the machines in facility 20 comprise single and/or multiple-axis machines, the latter having up to five or more axes.

Each machine in facility 20 is assumed to be controlled by its own respective CNC controller 42, 44, 46, and 48, which receive instructions for their operations directly or indirectly from workstation 26. In some embodiments each of the machines may be operated, via its respective CNC controller, by a machine technician, who may operate more than one of the machines. Alternatively, the CNC controller of a machine in facility 20 may be directly controlled from workstation 26, in which case the machine may not require a machine technician. For simplicity, in the description herein all machines in facility 20 are assumed to be under the overall direct control of workstation 26.

Workstation 26 comprises a central processing unit (CPU) 50, which is typically a multi-core unit. Typically, the multi-core unit uses multiple parallel threads in order to improve its efficiency of operation already within each calculation. In order to perform its operations, CPU 50 communicates with a large fast volatile random access memory (RAM) 52, which is typically of the order of 2 Gbytes or larger. The CPU also communicates with a non-volatile memory 54 such as one or more hard discs. Memory 54 is typically significantly slower than the volatile memory.

Toolpath calculating system 22 comprises software, the elements of which are described herein, which is stored in RAM 52 and in other memories of elements of system 22. The software may be downloaded to workstation 26 in electronic form, over a network, for example, or it may, alternatively or additionally, be provided and/or stored on non-transitory tangible media, such as magnetic, optical, or electronic memory.

As described herein, workstation 26 is configured to formulate a full toolpath file 56 which comprises a number of different toolpaths. By way of example, each toolpath is assumed to comprise a set of instructions for processes, or “sub-toolpaths,” which are followed by a single machine in facility 20.

Typically the evaluation of the toolpaths comprised in file 56 is computationally highly intensive. Thus in prior art systems the toolpath evaluations, even for a workstation with a large amount of RAM and a high-end multi-core unit, may be extremely demanding in terms of CPU usage.

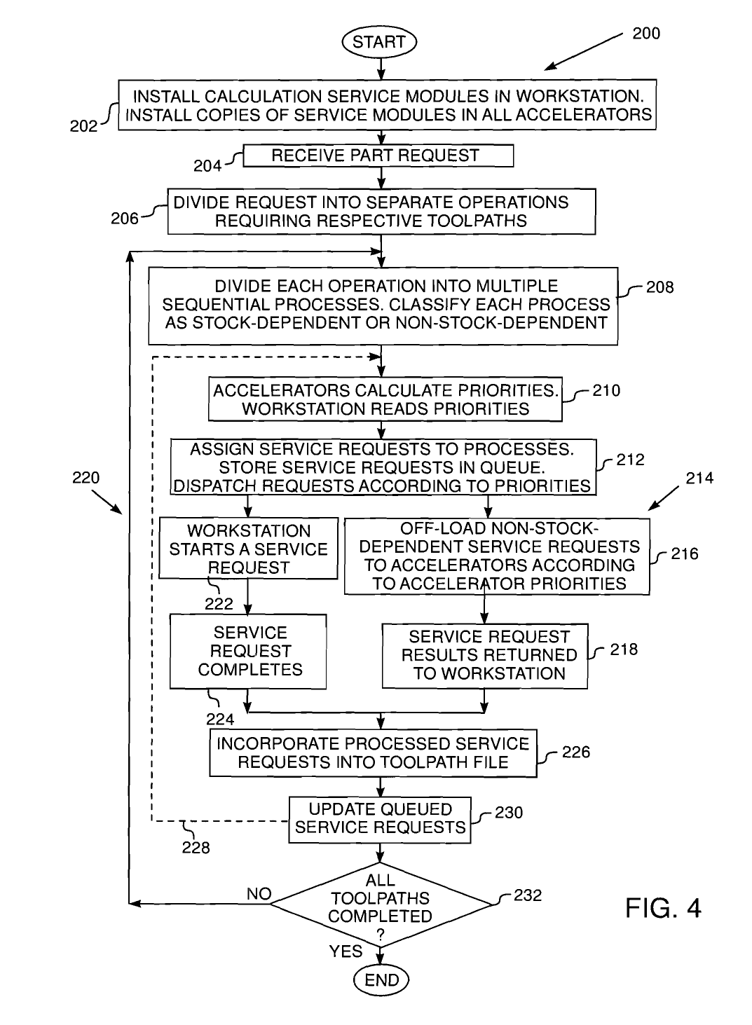

Some of the processes comprised in the toolpaths may be evaluated by CPU 50, using a number of calculation services 58A, 58B, . . . , generically referred to herein as calculation services 58, which are instantiated in RAM 52 and which are invoked in response to calculation service requests stored in a request queue 60. The generation and function of the service requests, and the function of the calculation services, are described in more detail below with respect to FIG. 4. It will be understood that evaluation of the toolpath processes by CPU 50 generates a high demand on the CPU.

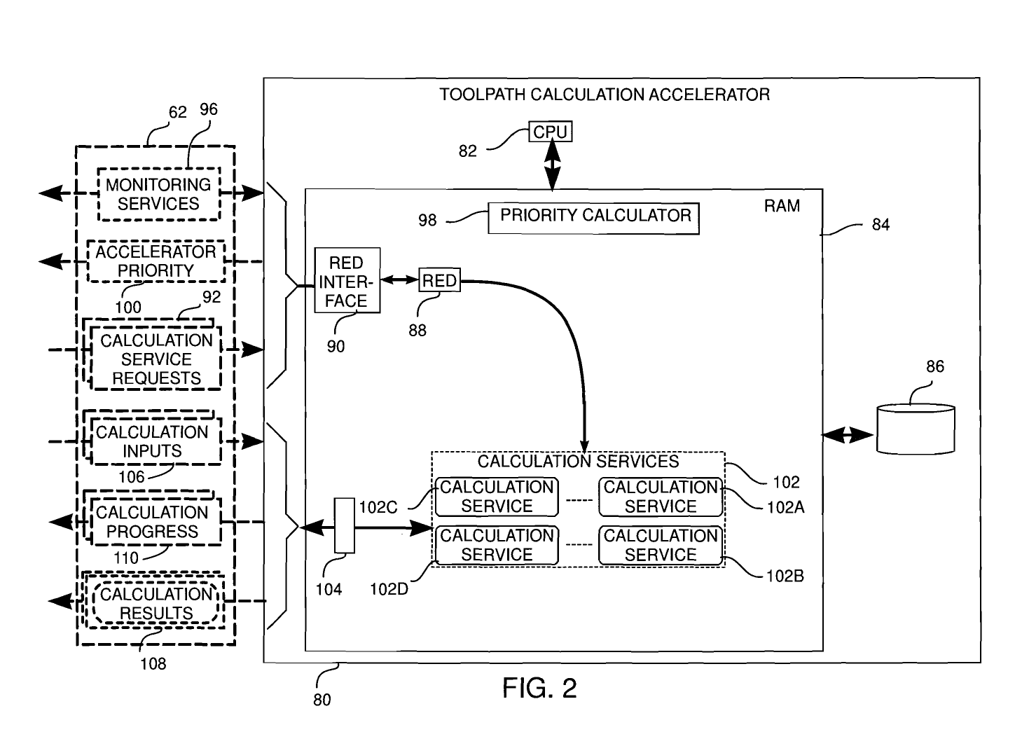

Embodiments of the present invention alleviate the demand on CPU 50 by transferring some or all of the queued requests to one or more toolpath calculation accelerators such as an accelerator 80 (not shown in FIG. 1). A schematic block diagram of toolpath calculation accelerator 80 is shown in FIG. 2. The requests, and the accelerators to which the requests are to be transferred, are selected according to priorities of the accelerators and of the workstation. A priority 68 of workstation 26, is calculated by a priority calculator module 70 resident in RAM 52. As described below, accelerators 80 also have modules which calculate respective priorities of the accelerators.

In order to implement the requests transfer and to receive the results from the accelerators, workstation 26 is coupled to the accelerators via a data transfer network 62. Herein, by way of example, the requests and results are assumed to be transferred between the network and the workstation using a remote execution dispatcher (RED) data transfer module 64, and a RED application programming interface (API) module 66, both modules residing in the workstation and also in the accelerators. The two modules may be based on the Windows Communication Foundation (WCF) system produced by Microsoft Corporation of Redmond, WA. However, any other suitable method of data transfer may be used by system 22 in transferring its data between the workstation and accelerators 80.

Thus, the calculation service requests stored in queue 60 are processed either by the calculation services of workstation 26, or by the calculation services of the accelerators connected to the network. In both cases, the CPU of the workstation receives the results generated by the calculation services, and uses the results to construct full toolpath file 56.

Network 62 is typically a local area network (LAN) that is firewalled to prevent external communication to or from the accelerators and workstation 26. Network 62 typically uses optical and/or conductive cabling for its data transfers, although at least some of the data transfers may comprise transfer using wireless electromagnetic radiation. In one embodiment the LAN is configured over the same subnet, and may use static IP (Internet protocol) or dynamic IP provided by a router.

FIG. 2 is a schematic block diagram of toolpath calculation accelerator 80, according to an embodiment of the present invention. The accelerator comprises a CPU 82, coupled to a RAM 84 and non-volatile memory 86. CPU 82, RAM 84, and non-volatile memory 86 are respectively generally similar to CPU 50, RAM 52, and non-volatile memory 54. CPU 82 is typically a fast multi-core unit such as an Intel® Core™ i7-2600K processor produced by Intel Corporation of Santa Clara, Calif., or similar processor in terms of frequency and cache size; and RAM 84 is typically of the order of 16 Gbytes or larger.

Accelerator 80 is connected to network 62 via a RED transfer module 88 and an API module 90, which are resident in RAM 84 and which are respectively generally similar in function to RED module 64 and API module 66. The modules facilitate the transfer of calculation service requests 92 which originate at workstation 26. Modules 88 and 90 also facilitate transfer of monitoring service data 96 to and from a controller of network 62. The controller of the network may comprise workstation 26 or another system connected to the network. The controller uses the monitoring service data to oversee the actions and state of accelerator 80.

A priority calculator module 98, resident in RAM 84, is generally similar to module 70, and is used by the CPU to calculate an accelerator priority 100 for accelerator 80. Modules 88 and 90 are also used to transfer the accelerator priority to the network. Accelerator priority 100 is compared with priorities of other accelerators on the network, and the comparison is used by workstation 26 in deciding which calculation service requests are to be transmitted to accelerator 80 and which are to be transmitted to the other accelerators.

RAM 84 also comprises a number of calculation services 102A, 102B, . . . , generically referred to herein as calculation services 102. Services 102 are respectively substantially similar to services 58 of workstation 26, and provide substantially the same functions as the services of the workstation. The calculation services of accelerator 80 interface with network 62 via a calculation service interface module 104. Module 104 transfers calculation input data 106, derived from workstation 26, and retrieved from the network, for use by services 102. Module 104 also transfers calculation results 108, generated by one or more services 102 in response to requests 92 and input data 106, to workstation 26 via the network. In addition to formulating calculation results, the services generate data 110 on the progress of the calculations, and module 104 transfers the progress data, via network 62, to workstation 26.

It will be appreciated that, unlike workstation 26, accelerator 80 has neither a GUI nor a communication instrument, so that operator 24 has no direct communication with the accelerator. In addition, unlike the workstation, accelerator 80 does not have a queue mechanism for requests. Once a decision is made by the workstation to send a request to the accelerator according to a method described below, the accelerator executes it immediately.

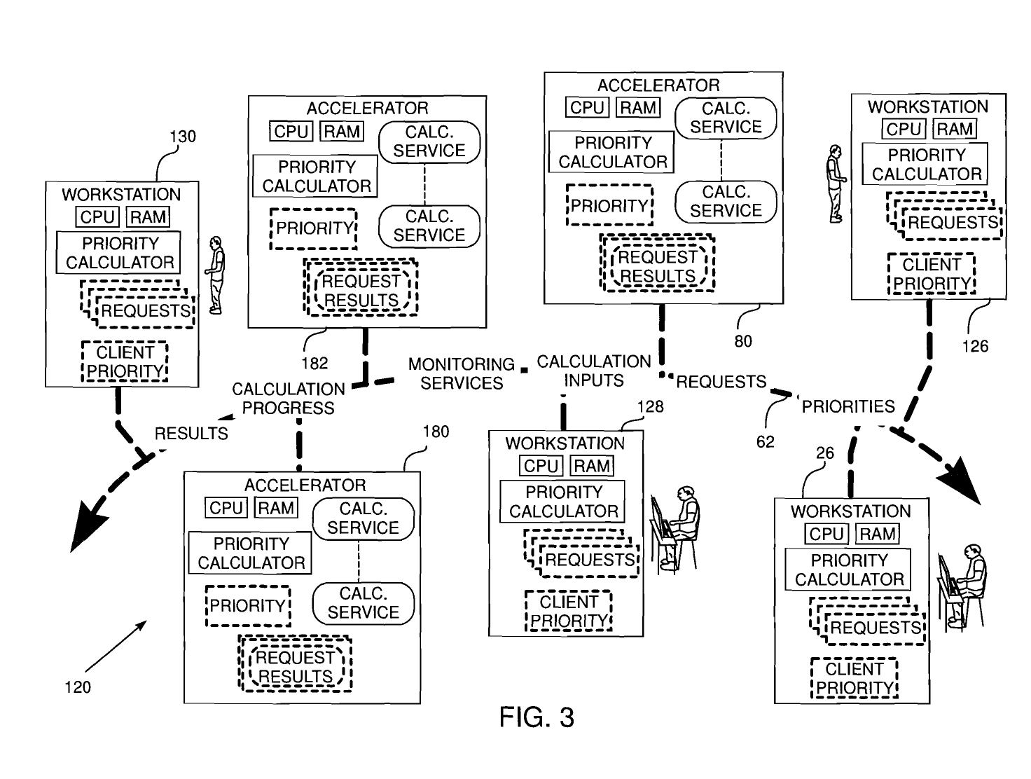

FIG. 3 is a schematic diagram of a toolpath generating arrangement 120, according to an embodiment of the present invention. Arrangement 120 comprises workstations 26, 126, 128, and 130, the latter three of which are assumed to be generally similar to workstation 26. Arrangement 120 also comprises toolpath calculation accelerators 80, 180, and 182; accelerators 180 and 182 are assumed to be generally similar to accelerator 80. For clarity and simplicity in FIG. 3, some of the elements related to the workstations and the accelerators are not shown, and/or are not labeled with numerical identifiers.

In arrangement 120, all the workstations and all the accelerators are connected to each other by network 62. Thus each of the four workstations is able to use the calculation services of all three accelerators in the arrangement. In addition, since each accelerator is able to handle the service requests of all the workstations, the processing of the service requests of the different workstations by a given accelerator is performed substantially simultaneously.

FIG. 4 is a flowchart 200, according to an embodiment of the present invention. The flowchart is assumed to describe steps followed within facility 20, i.e., by workstation 26 and by operator 24, when workstation 26 is connected as in arrangement 120 (FIG. 3).

In an initial step 202, operator 24 installs calculation services 58 in workstation 26. In addition, copies of calculation services 58 are installed in accelerators 80, 180, and 182. The installation of the services in the accelerators may be performed by operator 24. Alternatively, the installation of the services in the accelerators may be performed automatically by the accelerators querying each of the workstations on network 62 for their services. In some embodiments the automatic installation may be performed by the accelerators upon connection to the network.

In a toolpath request step 204, operator 24 receives a request requiring the production of full toolpath file 56 for a particular part. The toolpath request to the operator may be in the form of engineering drawings and/or files representative of the part to be produced. The files typically define the geometry of the part in a stereolithographic (STL) format, or in any other convenient parametric geometry format such as ACIS, produced by Spatial Corporation of Broomfield, Co, which produces a standard ACIS text (SAT) file. The full toolpath file to be produced is typically written in a standard CNC programming language such as G-code or Automatically Programmed Tool (APT) language. In a first analysis step 206, the operator analyzes the part to be produced to determine which of the one or more of the machines in facility 20 are to be used to produce the part. For each machine, the operator further determines one or more toolpath-operations that system 22 is to generate, each toolpath-operation requiring a separate toolpath calculation. For simplicity, a toolpath-operation may also be referred to herein simply as an operation.

For example, operator 24 may determine that machining center 28 is to be used for three separate milling toolpath-operations, and that turning center 34 is to be used for two lathe toolpath-operations between the milling operations. For this example, system 22 produces three toolpaths for the machining center, and two toolpaths for the turning center.

In a second analysis step 208, operator 24 divides each toolpath-operation into one or more sequential processes or sub-toolpaths. Typically each process of a sequence comprises initial and final geometric informational data of a surface comprised in the part. The geometric data of a process may lead to a well-defined process, i.e., the process is not dependent on any other process or toolpath-operation, and such a process is herein also termed a non-stock-dependent process. Another example of a non-stock-dependent process is one where previous processes remove sufficient material, typically a relatively large amount, so that accurate geometry of the remaining stock is not important.

Alternatively, the geometric data may lead to an ill-defined process, i.e., the process is dependent on implementation of prior processes or toolpath-operations, and such a process is herein also termed a stock-dependent process. In analysis step 208, operator 24 uses the above definitions to classify each process as stock-dependent or non-stock-dependent.

For example, the first milling operation exemplified above may be an operation starting from a known piece of raw stock, such as a cylindrical rod of mild steel of known diameter and length. The operation is considered to be the milling of six U-shaped grooves of a known depth along the rod, the grooves being symmetrically disposed around the central axis of the rod. In this case the operation comprises one process, and the process is well-defined or non-stock-dependent since both the initial and final geometries do not depend on other operations.

Continuing with the example, the first lathe operation (after the first milling operation) may comprise a first process of turning a chamfer on one of the ends of the milled rod, then a second process of forming a screw thread of known dimensions on the outer surface of the remainder of the milled rod. Both of these processes are ill-defined or stock-dependent, since the geometries of the initial stages depend either on the geometry produced by the first milling operation, or on the geometry produced from the chamfer process.

(It will be understood that while a process may be understood conceptually by the operator, for example the process is a requirement for milling, the process may be ill-defined from the point of view of system 22, since the calculation of the parameters of the process requires the system to know an initial and a final geometry of the process. Knowledge of these geometries allows system 22 to invoke appropriate calculation services so as to calculate an efficient toolpath for the process.)

Steps 202-208 require operator input. The following steps of flowchart 200 are executed seamlessly by workstation 26 and the accelerators of system 22, without any input from the operator, so that the operator may be unaware of the actions, or even be unaware of the presence, of the accelerators. The seamless execution occurs regardless of whether a specific process is stock-dependent or non-stock-dependent.

In a priority assignment step 210, workstation 26 reads priority value 100, calculated by calculator module 98, of accelerator 80, as well as the priority values of all other accelerators (calculated by the respective accelerators) on network 62. The priority value of an accelerator is typically calculated by the accelerator on an on-going basis, and is broadcast to all workstations on the network.

The priority value of a given accelerator is a measure of the ability and availability of the accelerator, compared to other accelerators on the network, to process a calculation service request. The higher its priority value, the more able is a given accelerator to process a service request. The priority value of an accelerator may be determined on the basis of the power of its CPU, the speed of its clock, the fraction of the CPU being used, and the fraction of RAM available. The last two factors are measured at the time of determination of the priority. Typically, the priority value is also a function of other hardware and software in the accelerator, such as one or more external floating point units and/or the operating system used by the accelerator.

In one embodiment, because calculations are CPU and RAM intensive, the priority of an accelerator is calculated according to equation (1) below.

P=A_{CPU}\sqrt{C}·B·V_{CPU}·\sqrt{RAM} (1)

where P is the priority value of the accelerator,

A_{CPU} is the fraction of the accelerator's CPU available,

C is the number of cores of the CPU,

B is a numerical factor related to hardware other than the CPU, as well as to software of the accelerator. B is a measure of the improvement in accelerator performance due to the hardware and the software,

V_{CPU} is the speed of the CPU clock, and

RAM is the amount of unused random access memory of the accelerator.

Workstation 26 may also calculate its own priority 68 (FIG. 1), by a method substantially as described above for the accelerators. In one embodiment, the workstation priority is reduced slightly, for example by multiplying by 0.9, to ensure that in the event of close priority values between a workstation and an accelerator, the accelerator receives the request.

In a queuing and dispatch step 212, CPU 50 assigns each process determined in step 208 to one or more requests for a calculation service. The calculation service requests are stored in queue 60. An indicator of the dependency of the process associated with the requests, i.e., if the calculation service requests are associated with a stock-dependent or non-stock-dependent process, is also stored in queue 60. As described below, the workstation dispatches the requests along one of two paths.

From step 212 the flowchart divides into two paths, which execute in parallel and simultaneously. In a first path 214, in a transfer step 216, CPU 50 transfers non-stock-dependent service requests 92 (FIG. 2) from queue 60 to accelerators 80, 180, and 182. The CPU may also transfer a stock-dependent request if it relies on a transferred non-stock-dependent request. Typically the first requests in the queue are transferred to the accelerator with the highest priority, i.e., the accelerator which is most able to process the request. Also in step 216, once CPU 50 has determined an accelerator for processing a particular service request, CPU 50 transfers calculation inputs 106 associated with the request to the accelerator.

As each request is transferred to a given accelerator, the priority of the accelerator will of necessity decrease, since the accelerator's CPU becomes less available and the amount of unused RAM decreases. In one embodiment requests in step 216 first transfer to the accelerator with the highest priority until its priority reduces to below the priority of the next highest priority accelerator. Requests are then transferred to the next highest priority accelerator. The process of step 216 continues until all non-stock-dependent requests have been transferred to accelerators, or until the priority of an accelerator is approximately equal to that of the workstation, or until the priority of an accelerator is below a pre-set limiting threshold value. The threshold value is typically set to ensure that an accelerator maintains a minimum calculation rate.

In a calculation step 218, while the accelerator is performing its requested calculation it provides calculation progress data 110 (FIG. 2) to workstation 26, allowing operator 24 to monitor the progress of the calculation. After the accelerator has performed its requested calculation, it returns results 108 of the calculation to workstation 26.

It will be understood that actions in path 214 do not rely on activity of operator 24.

In a second path 220, in a workstation step 222, operator 24 uses workstation 26 to select a calculation service request from queue 60. The request selected may, depending on the parameters of the calculation required, be a non-stock-dependent or a stock-dependent service request, since in the case of a stock-dependent request operator 24 may provide input to the workstation. Alternatively or additionally, the workstation may wait until a prior process completes, and use the results of the prior process for a stock-dependent service request.

In a calculation completion step 224, CPU 50 determines the results of the request.

The results from steps 224 and 218 enable some requests that were stock-dependent to convert to a non-stock dependent state, and thus to become available for processing on the workstation or the accelerators of the system.

In a full toolpath file assembly step 226, as results of service requests are received at the workstation (from calculations performed on the workstation and the accelerators) they are incorporated into the full toolpath file. The results are also available for examination by operator 24, typically using GUI 25.

In an update step 230, CPU 50 applies the results from steps 224 and 218 to update the indicator assigned to relevant service requests queued in step 210. (As explained above, the indicator shows whether a request is associated with a stock-dependent or a non-stock-dependent process.)

As shown by a broken line 228, the flowchart then returns to step 210. By way of example, and for simplicity, in the remaining description of flowchart 200 all service requests for a given toolpath are assumed to be processed before service requests for another toolpath are processed. It will be understood that in practice service requests for multiple toolpaths may be processed substantially in parallel.

The reiteration of steps 210-226 continues until all requests in queue 60, for the toolpath being evaluated, have been processed.

In a condition 232, CPU 50 checks if all toolpath-operations, defined in step 206, have completed. If there is a remaining toolpath-operation, the flowchart returns to step 208. If all toolpath-operations have completed, then flowchart 200 ends.

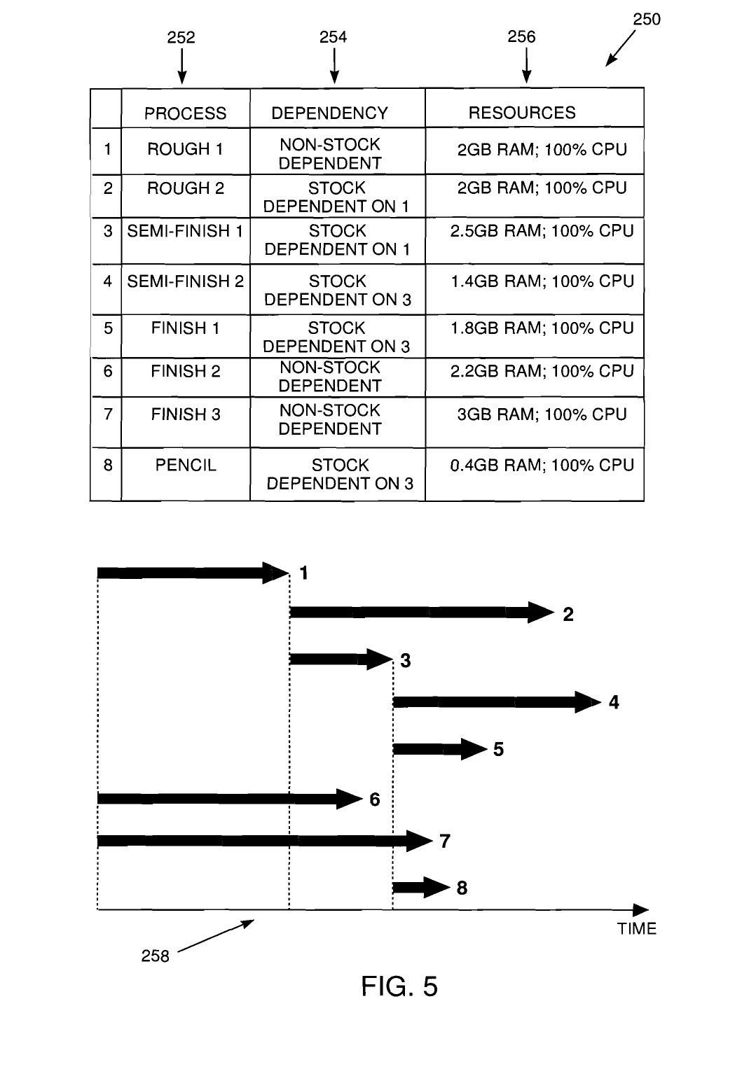

FIG. 5 is a schematic diagram illustrating full toolpath file generation, according to an embodiment of the present invention. A table 250 lists, in columns 252 and 254, eight processes of a toolpath operation that are classified by operator 24 as non-stock-dependent or stock-dependent. Typically, as is shown in column 254, the operator lists the immediate prior process that a stock-dependent process requires. Columns 252 and 254 correspond to operations performed by the operator in step 208 of flowchart 200. A column 256 lists exemplary computing resources required for calculating each process.

By way of example, the toolpath calculating system for generating the file is assumed to comprise workstation 26 and two accelerators 80. A synchronization chart 258 displays the time periods for each process using system 22. As is illustrated in the chart, multiple processes may be calculated simultaneously and in parallel. For example, since processes 1, 6, and 7 are all non-stock-dependent, the workstation could dispatch processes 6 and 7 respectively to the two accelerators, and calculate process 1 itself. These actions correspond to steps 212, 216, and 222 of flowchart 200. As the workstation and accelerators complete their calculations, they return their results to the workstation, and become available for further process calculations, corresponding to steps 218, 224, 226, and line 228 of the flowchart.

As is demonstrated by the synchronization chart, the simultaneous, parallel calculations performed by the workstation and accelerators significantly reduces the time taken to calculate the eight processes, compared to the time that would be taken for workstation 26 alone.

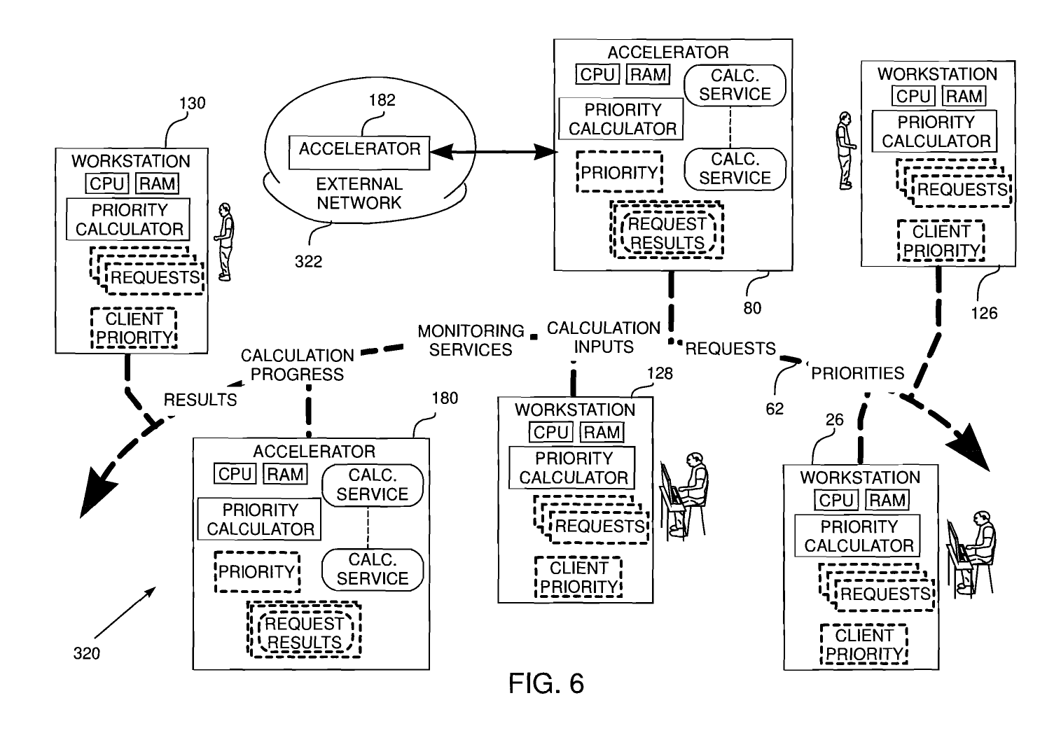

FIG. 6 is a schematic diagram of an alternative toolpath generating arrangement 320, according to an embodiment of the present invention. Apart from the differences described below, the operation of arrangement 320 is generally similar to that of arrangement 120 (FIGS. 1-4), and elements indicated by the same reference numerals in both arrangements 120 and 320 are generally similar in construction and in operation.

In arrangement 320 accelerator 182 is not connected directly to network 62 (as in arrangement 120). Rather, accelerator 182 is located on an external network 322, and is coupled to accelerator 80. This arrangement enables accelerator 80 to off-load some of its service requests, so effectively increasing its priority value. The increased priority value is registered by workstations 26, 126, 128, and 130 as they operate in arrangement 320. In addition, locating accelerator 182 on external network 322 facilitates provisioning of software to the accelerator. For example, workstation 128 may require a different version of a specific calculation service resident on accelerators 80 and 180, and the different version may be easily installed on accelerator 182 by an operator of the external network.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

We claim:

1. Apparatus, comprising:
a workstation, which is configured to receive a toolpath request and to generate a toolpath in response to the toolpath request, and which is configured to divide the toolpath request into multiple service requests and to output the service requests over a local network; and
a toolpath calculation accelerator coupled to receive at least one of the service requests from the workstation via the local network, and to process each received service request so as to generate a calculation result, and to transfer the calculation result to the workstation via the local network for incorporation of the calculation result into the toolpath generated by the workstation.

2. The apparatus according to claim 1, wherein the workstation is configured to associate each of the multiple service requests with one of a stock-dependent process and a non-stock-dependent process, wherein the non-stock-dependent process is not dependent on any other process, and wherein the stock-dependent process is dependent on prior implementation of another process.

3. The apparatus according to claim 2, wherein the at least one service requests received by the accelerator comprise requests associated with the non-stock-dependent process.

4. The apparatus according to claim 3, wherein the workstation is configured to process a given service request while the accelerator processes the at least one service requests.

5. The apparatus according to claim 3, wherein the workstation is configured to use the calculation result to associate a given service request, initially associated with the stock-dependent process, with the non-stock-dependent process.

6. The apparatus according to claim 1, wherein the workstation and the toolpath calculation accelerator are configured to calculate respective priorities indicative of an ability to process the at least one service requests.

7. The apparatus according to claim 6, wherein the workstation is configured to receive the respective priorities and output the at least one service requests to at least one of the workstation and the accelerator in response to the respective priorities.

8. The apparatus according to claim 7, and comprising a further toolpath calculation accelerator coupled to receive the at least one service requests from the workstation via the local network, and wherein the further toolpath calculation accelerator is configured to calculate a further-accelerator priority indicative of an ability to process the at least one service requests, and wherein the workstation is configured to receive the further-accelerator priority and output the at least one service requests to the workstation, the accelerator and the further toolpath calculation accelerator in response to the respective priorities and the further-accelerator priority.

9. The apparatus according to claim 1, and comprising a further workstation which is configured to receive a further toolpath request and to generate a further toolpath in response to the further toolpath request, and which is configured to divide the further toolpath request into multiple further service requests and to output the further service requests over the local network, and wherein the toolpath calculation accelerator is coupled to receive at least one of the further service requests, and to process each received further service request so as to generate a further calculation result, and to transfer the further calculation result to the further workstation via the local network for incorporation of the further calculation result into the further toolpath generated by the further workstation.

10. The apparatus according to claim 9, wherein the toolpath calculation accelerator is configured to process the at least one further service requests and the at least one service requests simultaneously.

11. A method, comprising:
configuring a workstation to receive a toolpath request and to generate a toolpath in response to the toolpath request, and to divide the toolpath request into multiple service requests and to output the service requests over a local network; and
coupling a toolpath calculation accelerator to receive at least one of the service requests from the workstation via the local network, and to process each received service request so as to generate a calculation result, and to transfer the calculation result to the workstation via the local network for incorporation of the calculation result into the toolpath generated by the workstation.

12. The method according to claim 11, wherein the workstation is configured to associate each of the multiple service requests with one of a stock-dependent process and a non-stock-dependent process, wherein the non-stock-dependent process is not dependent on any other process, and wherein the stock-dependent process is dependent on prior implementation of another process.

13. The method according to claim 12, wherein the at least one service requests received by the accelerator comprise requests associated with the non-stock-dependent process.

14. The method according to claim 13, wherein the workstation is configured to process a given service request while the accelerator processes the at least one service requests.

15. The method according to claim 13, wherein the workstation is configured to use the calculation result to associate a given service request, initially associated with the stock-dependent process, with the non-stock-dependent process.

16. The method according to claim 11, wherein the workstation and the toolpath calculation accelerator are configured to calculate respective priorities indicative of an ability to process the at least one service requests.

17. The method according to claim 16, wherein the workstation is configured to receive the respective priorities and output the at least one service requests to at least one of the workstation and the accelerator in response to the respective priorities.

18. The method according to claim 17, and comprising coupling a further toolpath calculation accelerator to receive the at least one service requests from the workstation via the local network, and configuring the further toolpath calculation accelerator to calculate a further-accelerator priority indicative of an ability to process the at least one service requests, and wherein the workstation is configured to receive the further-accelerator priority and output the at least one service requests to the workstation, the accelerator and the further toolpath calculation accelerator in response to the respective priorities and the further-accelerator priority.

19. The method according to claim 11, and comprising configuring a further workstation to receive a further toolpath request and to generate a further toolpath in response to the further toolpath request, and to divide the further toolpath request into multiple further service requests and to output the further service requests over the local network, and coupling the toolpath calculation accelerator to receive at least one of the further service requests, and to process each received further service request so as to generate a further calculation result, and to transfer the further calculation result to the further workstation via the local network for incorporation of the further calculation result into the further toolpath generated by the further workstation.

20. The method according to claim 19, wherein the toolpath calculation accelerator is configured to process the at least one further service requests and the at least one service requests simultaneously.
